(19) United States
(12) Patent Application Publication
(10) Pub. No.: US 2016/0370152 A1
(43) Pub. Date: Dec. 22, 2016

(54) Face Pin

(71) Applicant: Steven Tomkins, Giltbrook (GB)

(72) Inventor: Steven Tomkins, Giltbrook (GB)

(21) Appl. No.: 15/183,039

(22) Filed: Jun. 15, 2016

(30) Foreign Application Priority Data
Jun. 16, 2015 (GB) GB1010549.7

(51) Int. Cl. F41J 1/10; F41J 3/00; F16B 33/02

(52) U.S. Cl. CPC F41J 1/10; F16B 33/02; F41J 3/0004

(57) ABSTRACT

A face pin 1 has a head portion 2 comprising a grip section 4 for gripping by a user to manipulate the face pin 1, and an elongate body portion 3 that extends from the head portion 2, the body portion 3 having a free end 5 configured to in use pass through a target face into a target boss, at least part of the body portion 3 formed substantially helically.

### FIELD

The present invention relates to a face pin. More particularly, the present invention relates to an archery face pin for securing a target face to a target boss.

### BACKGROUND

Face pins are used in target sports, principally archery, to secure a target sheet or target face to a supporting target boss. A face pin is used to punch a hole in the target face (usually at or close to a corner or edge of the sheet), the pin then driven into the target boss to secure the target sheet in place on the target boss. A number of pins are usually used, with this process repeated at different locations on the target face (e.g. one at each corner of a square target) to secure the target face in the required flat position, ready for use. When the target face has been shot out and needs replacing, the face pins are pulled out of the target boss so that the pins and boss can be reused with a fresh target face. It is important that target faces are left in the correct position once set by the course layer, especially during competitions.

A number of different designs of known face pins are shown in FIGS. 1 to 3. All of these prior art pins have a smooth elongate body with a pointed or sharpened target end, and a head opposite the pointed end which acts as a combined user grip or handle, and a stop, the stop in use holding the target face on the target boss, and preventing the target face from sliding off the outer end of the pin.

Current face pins are used by simply driving them in and out of the target boss. One problem with the types of known face pins on the market is that because they are driven in and out, they can come loose from the target boss relatively easily. The smooth elongate body helps the pin to slide into the target boss easily when pushed in by a user. However, due to the smooth body, the pins are held in by friction only, and can slide out during use. For example, as archers pull their arrows free from the targets, the target face can pull on the pin via the head, pulling the pin free either partly or completely from the target boss. Similarly, weather conditions such as wind and rain can drag on the target face, causing this to pull on and loosen the pins, so that the target face is not held securely on the target boss, which can make the target face hang loose or fall on the floor. The pins may either come out completely and fall on the floor, or may just come partly out, leaving the target face not fully secured and potentially misaligned or baggy. In some case, the target faces may come loose enough to fall on the ground, which damages the face, and makes it necessary to replace the face before use.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a face pin which goes some way towards overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in a face pin, comprising: a head portion comprising a grip section for gripping by a user to manipulate the face pin, and; an elongate body portion that extends from the head portion, the body portion having a free end configured to in use pass through a target face into a target boss, at least part of the body portion formed substantially helically. The portion of the body formed substantially helically allows the face pin to be securely connected or attached to a target boss by screwing the helical portion of the face pin into the target boss.

In an embodiment, the head portion further comprises a flange located between the grip section and the body portion, the flange arranged substantially perpendicularly to the elongate body portion. The flange acts as a stop to prevent further movement of the face pin into the target boss.

In an embodiment, that part of the body portion formed substantially helically comprises a screw thread that extends at least part way along the elongate body portion. This is a simple and reliable way to form the helical portion.

In an embodiment, the screw thread extends from a point at or close to the flange to a point partway along the body section. This allows a user to locate the pin into the target boss using the non-helical portion before screwing the face pin in using the helical portion.

In an embodiment, the screw thread extends along the elongate body portion for substantially between 20 mm and 30 mm. This provides a balance between a thread sufficiently long so as to provide secure fastening, and an overly-long thread that would be difficult to fully screw into position.

In an embodiment, the screw thread has a thickness of substantially between 1 mm and 2 mm. This provides a balance between a thread sufficiently thick so as to provide secure fastening, and an overly-thick thread that would require considerable effort to fully screw into position.

In an embodiment, the screw thread is formed with a gap between the flange and the screw thread. This helps with forming the screw thread.

In an embodiment, the gap is substantially 1 mm. This helps with forming the screw thread.

In an embodiment, the grip section comprises a substantially flat section extending substantially parallel to the elongate body portion and configured to be grasped between the thumb and forefinger of a user. This allows a user to easily grasp and manipulate the pin.

In an embodiment, at least one of the faces of the flat section has a substantially central indent. This helps a user to easily grasp and manipulate the pin.

In an embodiment, the head portion and elongate body portion are formed as a unitary item. This simplifies manufacture of the pin.

In an embodiment, the flange is substantially circular and has a diameter of substantially between 10 mm and 20 mm. The size of the diameter provides a flange with a surface area sized so that there is a balance between providing sufficient surface area to provide an efficient stop surface, and an overly-large surface area that would interfere with the target and would make the pin unwieldy.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a prior art face pin produced by Avalon, the pin formed from a single continuous piece of metal bent and twisted to form a pin with a straight body that locates in a target boss in use, and a head that extends from the body and which in use extends from the front of the target boss.

FIG. 2 shows a prior art face pin produced by Beiter, the pin formed as a single item from plastic moulding and having an elongate body and a flat planar head aligned with the elongate body.

FIG. 3 shows a prior art face pin having a metal body, and a head at least partly formed from plastic, with a flange formed between the head and the body that extends perpendicular to the body so that when in position on a target boss the flange part abuts the front face of the target face, the head formed as a ring that extends from the flange portion and which a user can grip for ease of removal.

FIG. 4 shows a perspective view from one side and above of an embodiment of face pin of the present invention, the face pin having an elongate body portion that in use passes through a target face into a target boss, and a head portion that comprises a flange arranged perpendicular to the axis of the elongate body portion, and a gripping and twisting section that extends perpendicularly to the flange on the opposite side from the elongate body section, the elongate body section partially threaded, the thread extending partway along the body section from the flange.

FIG. 5 shows a side view of the face pin of FIG. 4, the pin aligned so that the gripping and twisting section is aligned side-on.

FIG. 6 shows a cutaway side view of the face pin of FIGS. 4 and 5, with the pin aligned so that the gripping and twisting section is edge-on or end-on.

FIG. 7 shows a top view of the face pin of FIGS. 4 to 6.

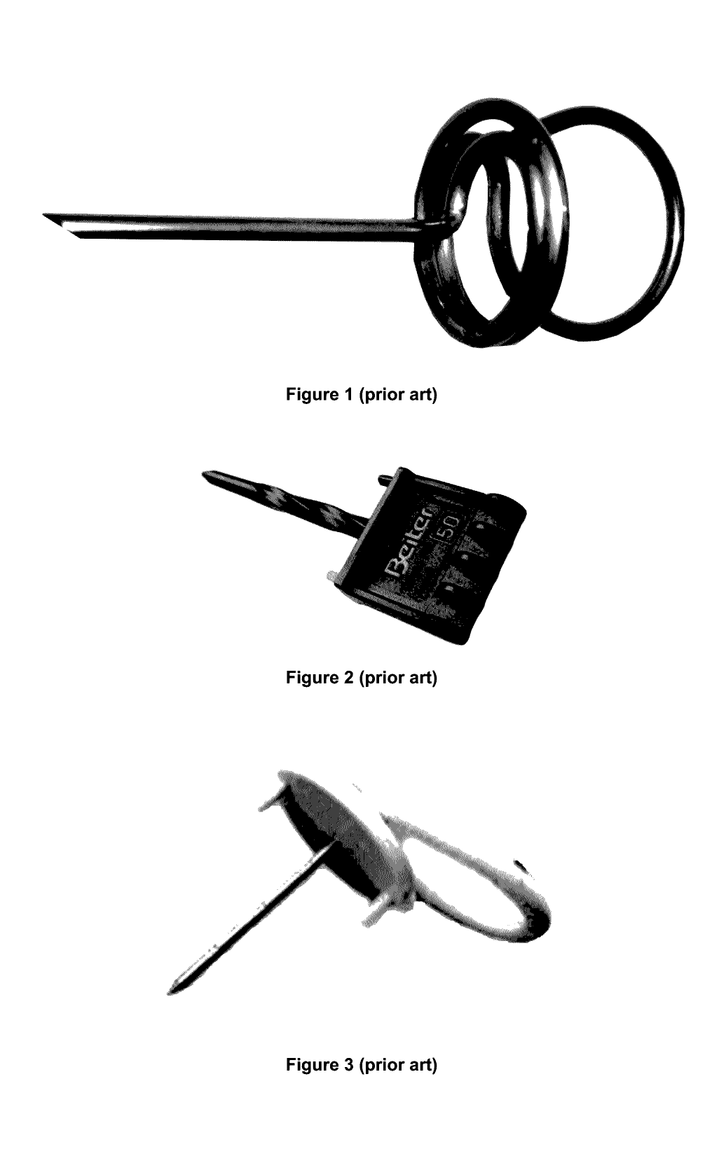

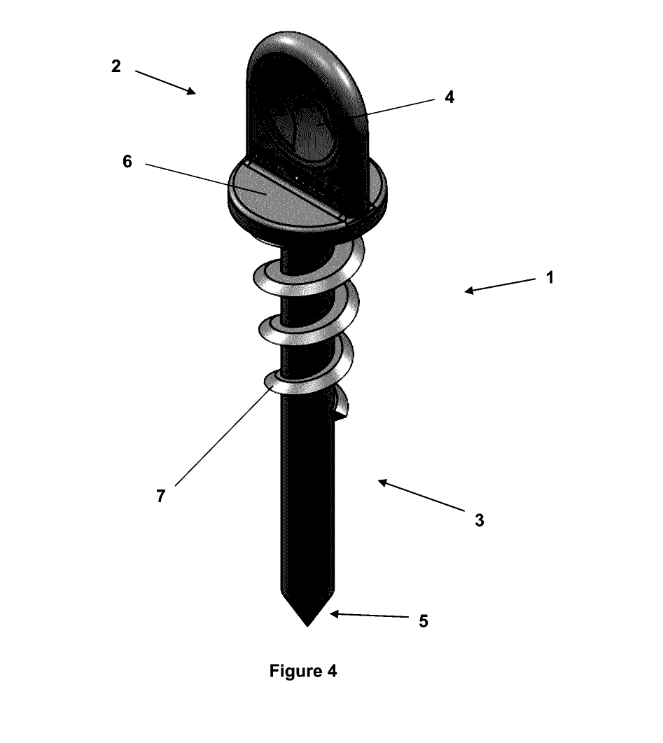

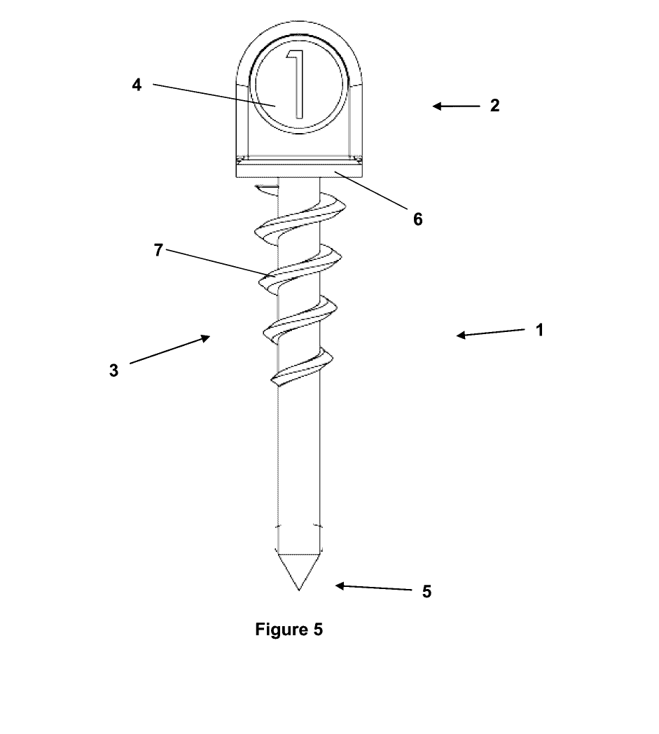

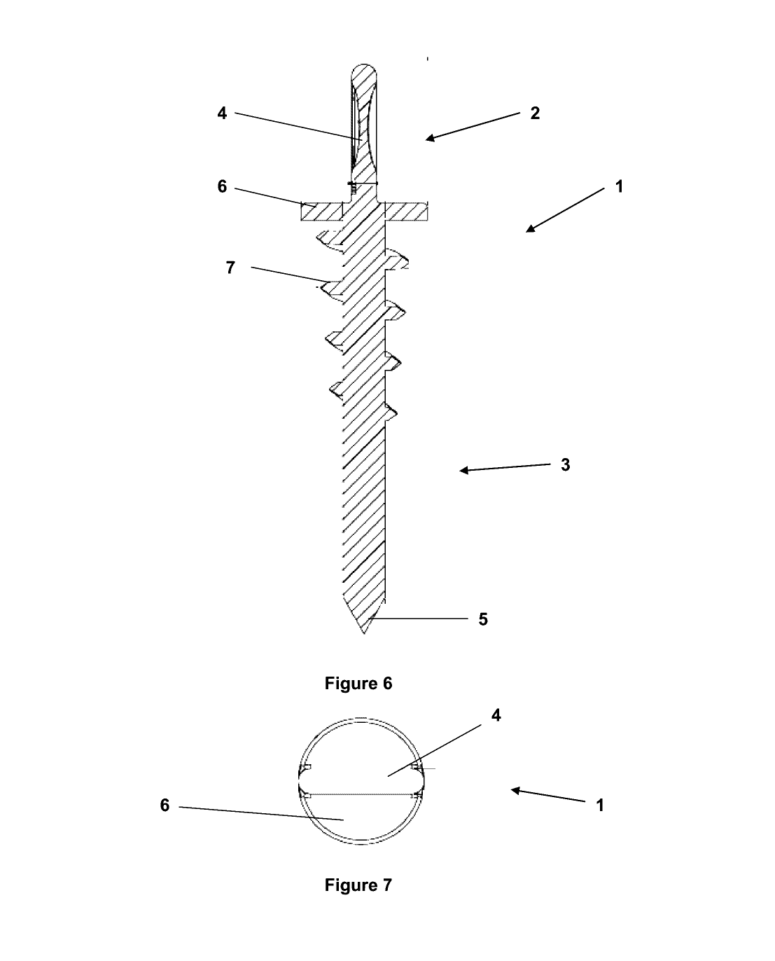

### DETAILED DESCRIPTION

An embodiment of the face pin of the present invention will now be described with reference to the figures.

The face pin 1 has two main parts: a head portion 2 and an elongate body portion 3. The structure of these is described in detail below. However, it should be noted that in the embodiment described, the head portion 2 and elongate body portion 3 are formed as a unitary item.

### Head

The head portion 2 has two sub-parts: a grip section 4 and a flange 6. The grip section 4 is generally flat, and is shaped so that from the side it has a rounded top. In use, a user grasps the flat section between their finger and thumb, or holds it in a similar fashion, to manipulate the face pin 1. The centre of the faces on each side of the grip section 4 are indented so that the tips of a user's fingers can locate into the indent to make grasping and manipulating the face pin 1 easier.

The flange 6 is located at the base of the grip section 4, and extends perpendicularly to the grip section 4. The flange 6 is substantially circular and has a diameter of 15 mm, and a thickness of around 1 mm. As shown in the figures, the grip section 4 extends from one side of the perimeter of the flange 6 to the other, across the centre of the flange 6.

### Body

In this embodiment, the body portion 3 is formed as a long, straight, thin elongate body, circular in cross-section, that extends from the centre of the flange 6 at one end, on the opposite side of the flange to the grip section 4. The other end of the body portion 3, away from the flange 6, forms a free end 5 that in use pierces through a target face into a target boss. The body portion 3 is in this embodiment around 50 mm long.

A helical screw thread 7 is formed on, and as part of, the body portion 3. The screw thread 7 is formed so that the thread 7 extends from a point close to the flange 6 to a point partway along the body section 3. That is, the screw thread 7 extends along the elongate body portion from the flange 6 towards the free end 5 for approximately 30 mm. The screw thread has a thickness of substantially between 1 mm and 2 mm.

In this embodiment, the screw thread is formed such that there is a gap of approximately 1 mm between the flange and the screw thread. The face pin 1 of the preferred embodiment is formed as a single or unitary item, by injection moulding from plastic.

In use, a user positions the target face on the target boss, and then drives the free end of the face pin 1 through the target face and into the target boss behind. That part of the body section 3 closest to the free end 5 has a smooth external surface, so this part of the face pin 1 can be driven straight into the target boss to initially hold the target face in position. Once the pin 1 has been pushed into the target boss a certain distance, the threaded section will contact the target boss (as it passes through the target face, which is against the target boss). A user can then twist the face pin 1 to screw the face pin 1 into the target boss, until the inner face of the flange 6 is flush against the target face, which is flush against the target boss (i.e. the target face is sandwiched between the inner face of the flange 6 and the target boss). That is, the inner face of the flange 6 comes into contact with the target face, and presses this flush against the target boss. As the flange 6 extends perpendicularly to the sides of the body portion 3, the flange 6 acts as a stop to prevent further movement of the face pin 1 into the target boss.

A face pin formed according to the invention, such as face pin 1 of the embodiment described above, helps to overcome the problems associated with face pins of the known, prior art, type. The pin 1 will stay screwed in, even with a great amount of pulling force. This will help to save archery clubs money, as they will lose fewer pins, damage fewer faces, and the target faces need less managing. Once a target face is in the required position, users know that it will remain in position. For example, a face can be located in position the day before a competition, and will be there the next day for the competition, no matter how bad the weather was overnight. The face pin will not come out without being unscrewed.

It should be noted that the dimensions and shapes outlined above can be altered without departing from the scope of the invention. For example, the length of the pin 1 can be altered, and the relative lengths of the threaded and straight portions can be altered. The entire length of the body portion could be threaded in alternative forms.

As an alternative, at least part of the body portion itself could be formed substantially helically or spirally, or similar, allowing the body portion to be screwed into a target boss. The threaded portion could also be formed separately to the main part of the body portion—for example as a separate sleeve passed over and connected to the body portion to then form part of the body portion—rather than forming the threaded section as an integral part of the body portion.

1. A face pin, comprising:
a head portion comprising a grip section for gripping by a user to manipulate the face pin;
an elongate body portion that extends from the head portion, the body portion having a free end configured to in use pass through a target face into a target boss, at least part of the body portion formed substantially helically.

2. A face pin as claimed in claim 1 wherein the head portion further comprises a flange located between the grip section and the body portion, the flange arranged substantially perpendicularly to the elongate body portion.

3. A face pin as claimed in claim 1 wherein that part of the body portion formed substantially helically comprises a screw thread that extends at least part way along the elongate body portion.

4. A face pin as claimed in claim 3 wherein the screw thread extends from a point at or close to the flange to a point partway along the body section.

5. A face pin as claimed in claim 4 wherein the screw thread extends along the elongate body portion for substantially between 20 mm and 30 mm.

6. A face pin as claimed in claim 3 wherein the screw thread has a thickness of substantially between 1 mm and 2 mm.

7. A face pin as claimed in claim 4 wherein the screw thread is formed with a gap between the flange and the screw thread.

8. A face pin as claimed in claim 7 wherein the gap is substantially 1 mm.

9. A face pin as claimed in claim 1 wherein the grip section comprises a substantially flat section extending substantially parallel to the elongate body portion and configured to be grasped between the thumb and forefinger of a user.

10. A face pin as claimed in claim 9 wherein at least one of the faces of the flat section has a substantially central indent.

11. A face pin as claimed in claim 1 wherein the head portion and elongate body portion are formed as a unitary item.

12. A face pin as claimed claim 1 wherein the flange is substantially circular and has a diameter of substantially between 10 mm and 20 mm.
